(19) United States
(12) Patent Application Publication
(10) Pub. No.: US 2019/0217189 A1
(43) Pub. Date: Jul. 18, 2019

(54) VR SYSTEM FOR TRACKING THREE TYPES OF PHYSICAL COMPONENTS

(71) Applicant: Unchartedvr Inc., San Rafael, CA (US)

(72) Inventors: KALON ROSS GUTIERREZ, Corte Madera, CA (US); DOUGLAS GRIFFIN, Mill Valley, CA (US); JOHN DUNCAN, San Anselmo, CA (US); CHARLES BUECHE, San Francisco, CA (US)

(21) Appl. No.: 16/249,485

(22) Filed: Jan. 16, 2019

Related U.S. Application Data
(60) Provisional application No. 62/618,038, filed on Jan. 16, 2018.
(60) Provisional application No. 62/618,030, filed on Jan. 16, 2018.

(51) Int. Cl. A63F 13/25; G06F 3/01; G06T 7/73; A63F 13/285; A63F 13/80; A63F 13/30

(52) U.S. Cl. CPC A63F 13/25; G06F 3/016; G06T 7/73; H04W 84/12; A63F 13/80; A63F 13/30; G06T 2207/10028; A63F 13/285

(57) ABSTRACT

A virtual reality (VR) system is provided that mixes real-world tactile stimulation with audiovisual stimulation provided through VR headgear. The VR system uses three sets of components. The first set comprises mobile objects that are tracked using motion tracking LEDs. The second set comprises stationary objects that are tracked using wires connected to an I/O controller to a game server. The third set comprises objects that are not tracked at all, but which are depicted with a thematic rendering in the VR world. A grid is set up that provides discrete locations for setting up both stationary and mobile components. A VR game server serves constructs of a VR world having thematically-embellished virtual objects that appear to be located in positions and orientations that match the positions and orientations of the components of the first, second, and third sets.

### CROSS-REFERENCE TO RELATED APPLICATIONS

This application claims the benefit of our U.S. Provisional Patent App. No. 62/618,038, filed Jan. 16, 2018. This application also claims the benefit of related U.S. Provisional Patent Application No. 62/618,030, also filed Jan. 16, 2018, entitled “Registering and Calibrating Physical Props Used in a VR World.”

This application is related to the following co-pending U.S. Patent Applications, each of which has a common assignee and common inventors.

| | FILING | |
|---|---|---|
| SER. NO. | DATE | TITLE |
| 15/783,664 | Oct. 13, 2017 | MODULAR SOLUTION FOR DELIVERING A VIRTUAL |
| (DVR.0101) | | REALITY ATTRACTION |
| 15/828,198 | Nov. 30, 2017 | METHOD FOR GRID-BASED VIRTUAL REALITY |
| (DVR.0101-C1) | | ATTRACTION |
| 15/828,257 | Nov. 30, 2017 | GRID-BASED VIRTUAL REALITY ATTRACTION SYSTEM |
| (DVR.0101-C2) | | |
| 15/828,276 | Nov. 30, 2017 | SMART PROPS FOR GRID-BASED VIRTUAL REALITY |
| (DVR.0101-C3) | | ATTRACTION |
| 15/828,294 | Nov. 30, 2017 | MULTIPLE PARTICIPANT VIRTUAL REALITY ATTRACTION |
| (DVR.0101-C4) | | |
| 15/828,307 | Nov. 30, 2017 | GRID-BASED VIRTUAL REALITY SYSTEM FOR |
| (DVR.0101-C5) | | COMMUNICATION WITH EXTERNAL AUDIENCE |
| 62/571,638 | Oct. 12, 2017 | MODULAR SOLUTION FOR DELIVERING A VIRTUAL |
| (DVR.0102) | | REALITY ATTRACTION |
| 62/618,030 | Jan. 16, 2018 | REGISTERING AND CALIBRATING PHYSICAL PROPS USED |
| (DVR.0110) | | IN A VR WORLD |
| 62/624,754 | Jan. 31, 2018 | POROUS INTERACTIVE MULTI-PLAYER VR GAME |
| (DVR.0112) | | SYSTEM |
| 62/624,756 | Jan. 31, 2018 | MULTI-PLAYER VR GAME SYSTEM WITH NETWORK |
| (DVR.0113) | | PARTICIPATION |
| 62/624,760 | Jan. 31, 2018 | PLAYER-SPECIFIC VR REPRESENTATIONS OF A VR |
| (DVR.0114) | | WORLD |
| 16/241,540 | Jan. 7, 2019 | HYBRID HAND TRACKING OF PARTICIPANTS TO CREATE |
| (DVR.0115) | | BELIEVABLE DIGITAL AVATARS |
| 16/241,579 | Jan. 7, 2019 | HYBRID HAND AND FINGER MOVEMENT BLENDING TO |
| (DVR.0116) | | CREATE BELIEVABLE AVATARS |
| 62/620,378 | Jan. 22, 2018 | SAFE SPACE MECHANISM FOR VIRTUAL REALITY |
| (DVR.0117) | | GAMEPLAY |

The aforementioned applications are herein incorporated by reference for all purposes.

### BACKGROUND OF THE INVENTION

### Field of the Invention

This invention relates in general to the field of virtual reality attractions, and more particularly to virtual reality attractions that blend physical elements with VR representations.

### BRIEF DESCRIPTION OF THE DRAWINGS

These and other objects, features, and advantages of the present invention will become better understood with regard to the following description, and accompanying drawings where:

FIG. 1 illustrates one embodiment of a modular stage with a first arrangement of stage accessories to augment the illusion of a first VR experience;

FIG. 2 illustrates the modular stage of FIG. 1 with a second arrangement of stage accessories to augment the illusion of a second VR experience;

FIG. 3A illustrates the modular stage of FIG. 1 illustrating a labeled grid of separable modular stage sections, each having a plurality of peg holes for fixing the stage accessories to the modular stage;

FIG. 3B is an enlarged view of a separable modular stage section, showing a labeled secondary grid of peg holes in the modular stage section;

FIG. 4 is a perspective view of a wall equipped with pegs positioned over holes in a portion of the modular stage;

FIG. 5 illustrates a building façade accessory mounted on a modular stage;

FIG. 6 illustrates a VR representation of the building façade, embellished with an appearance of log siding and a tiled roof in a wooded surrounding;

FIG. 7 illustrates a VR participant holding a flashlight prop while pushing open a door of the building façade;

FIG. 8 illustrates a VR representation of an aged industrial doorway, with a flashlight-illuminated area that corresponds to the direction in which the flashlight prop is pointing;

FIG. 9 illustrates a VR participant walking over a wooden plank prop positioned on a modular stage platform;

FIG. 10 illustrates a corresponding VR representation of the wooden plank positioned over a deep gap separating two buildings;

FIG. 11 illustrates an elevator simulator on the modular stage;

FIG. 12 illustrates a corresponding VR representation of a VR elevator;

FIG. 13 illustrates a VR participant holding a firearm prop; and

FIG. 14 illustrates a corresponding VR representation provided to the VR participant as he holds the firearm prop.

FIG. 15 illustrates one embodiment of an inventory-management system for keeping track of and correctly aligning props.

FIG. 16 illustrates one embodiment of a method of arranging props inside an operator-managed space, registering the props, and identifying misalignments of any of the props.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein but is to be accorded the widest scope consistent with the principles and novel features herein disclosed.

The present invention will now be described with reference to the attached Figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

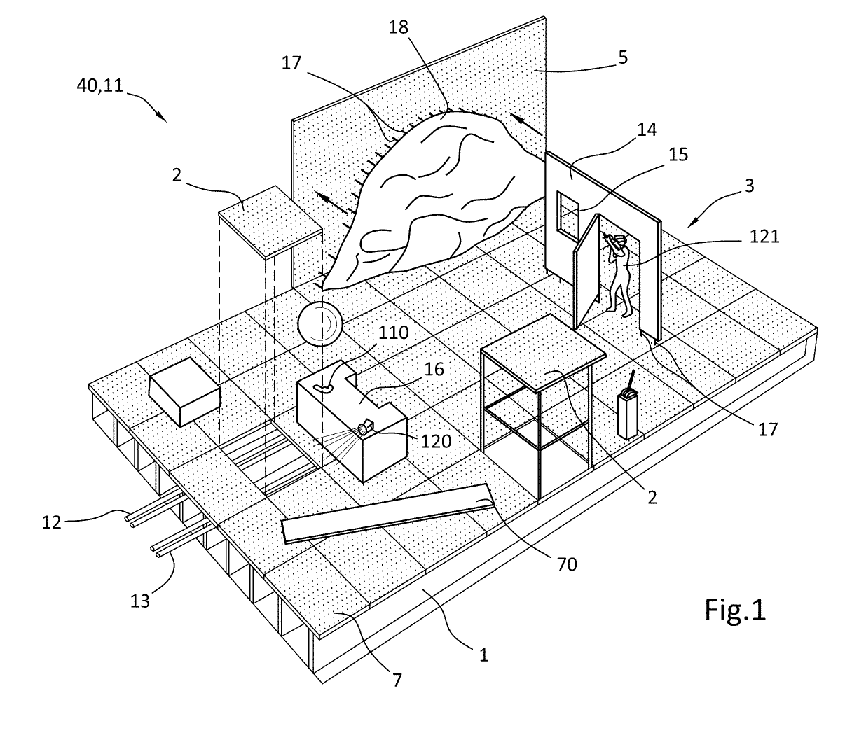

FIG. 1 illustrates one embodiment of a modular stage 1 with a first grid aligned arrangement 11 of stage accessories 14, 16, 18, 70, 110, 120 to augment the illusion of a first VR experience/representation. The stage accessories 14, 16, 18, 70, 110, 120 are provided as part of a VR stage kit 11. The stage accessories 14, 16, 18, 70, 110, 120 are assembled to the stage 1 according a plurality of stage plans or arrangements that correspond to a plurality of VR representations (aka “VR worlds”) provided in a VR attraction. The stage accessories 14, 16, 18, 70, 110, 120 include set pieces and props. For example, FIG. 1 illustrates a façade 14 with a window 15 and door 6, a rock 18 attached to a perimeter wall 5, a flashlight prop 120 and a firearm prop 110 resting on a desk 16, and a plank 70 on resting on a floor of a modular stage platform 3. The accessories 14, 16, 18, 70, 110, 120 give virtual reality participants sensory feedback that augments a virtual reality representation. Some of the accessories 14, 16, 18, 70, 110, 120 may comprise fittings 17 (such as pegs) to mount them to the modular stage platform 3.

A modular stage 1 comprises a plurality of separable modular stage sections 2 designed to fit and cooperate with each other for ease of assembly to form the stage 1. The modular stage 1 and its kit 11 of stage accessories 14, 16, 18, 70, 110, 120 are configurable to fill a discrete set of spatial areas—for example, 10 meters by 20 meters and 15 meters by 15 meters—that might be found in a mall, theater, or other retail space. Different spatial representations of a VR world are created to fit one or more of these areas and correspond to one or more stage plans or arrangements of accessories 14, 16, 18, 70, 110, 120 on the stage 1.

In one embodiment, the modular stage 1 comprises a commercially available stage kit (not to be confused with the accessory kit 11 described herein). Discretely positioned (and preferably regularly spaced) accessory mounts 7 are either provided with, or incorporated into, the stage 1. In one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

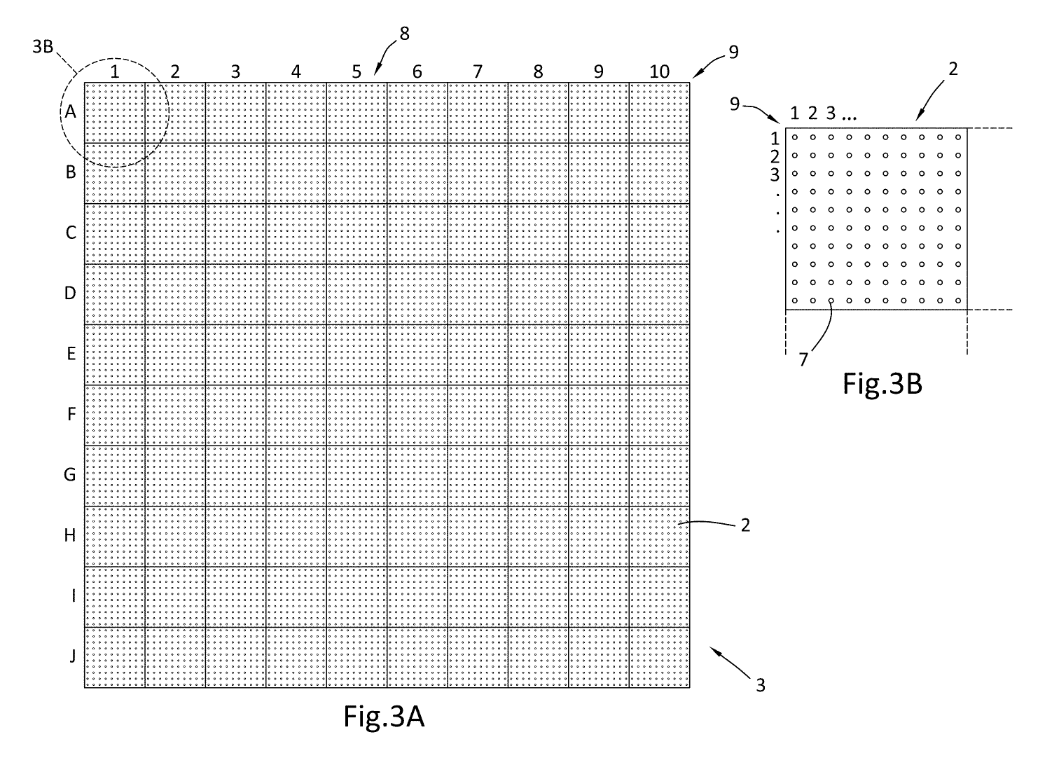

FIG. 3A illustrates a modular stage platform 3 made up of separable squares or platform sections 2. For example, each square 2 may be 1m×1m. FIG. 3B illustrates each square 2 as providing multiple aligned rows of accessory mounts 7 in the form of holes that are spaced 1 decimeter (for example) apart from each nearest accessory mount 7. The squares 2 are adapted to be connected to each other to create platforms 3 of different rectilinear dimensions. This enables the modular stage 1 to fit a wide range of conventional leasable commercial spaces.

The accessory mounts 7 are placed at preselected coordinates in a grid-like fashion in order to provide discrete places, readily and accurately represented in a VR world, for the mounting of the stage accessories 14, 16, 18, 70, 110, 120. In one practical embodiment, the accessory mounts 7 are peg holes that are regularly spaced and configured for receiving accessories that have cooperating pegs. In this application, the term “peg” is used in a broad sense to encompass large structures as well as small structures. The peg holes 7 may be round, square, dimensioned to receive a dimensional board, or some other shape. The peg holes 7 are defined by a surrounding structure that, in conjunction with cooperating fittings or mounts 17 (e.g., pegs), provide sufficient strength to fix and stabilize any mounted accessory 14, 16, 18, 70, 110, 120. In an alternative embodiment, the stage platform 3 is modified to incorporate pegs 17 for receiving accessories 14, 16, 18, 70, 110, 120 with cooperating holes 7.

Any suitable substitute for a peg-and-hole system would also fall within the scope of the present invention, including mounts in the form of seats, sockets, interconnectors, fasteners, couplers, couplings, clamps, hand-operated quick-release clasps, ties, pins, snaps, links, and the like. The scope of the invention also includes any arrangement of female and male parts that attach one object to another, provided that they facilitate quick assembly and disassembly.

Collectively, the peg holes or other accessory mounts 7 of the modular stage platform 3 are aligned within rectilinear rows and columns, forming a grid or regular pattern 8. In one embodiment, the stage sides have a primary set of alphanumeric markings 9, respectively, to identify each square 2 in the modular stage. In the 1 meter by 1 meter square embodiment, this grid density provides a 1 meter by 1 meter level of resolution. Each square or alternatively dimensioned platform section 2 may also be labeled with its own secondary set of alphanumeric markings 9, to identify each accessory mount 7 in the square or section 2. In the 100-holes per square embodiment, this grid density provides a 1-decimeter by 1-decimeter level of resolution. The invention is, of course, not limited to these square dimensions or grid densities.

The assembly of the accessories 14, 16, 18, 70, 110, 120 to the modular stage platform 3 makes use of the positioning grid 8. For example, as noted above, many of the accessories 14, 16, 18, 70, 110, 120 are arranged with fittings 17 (such as pegs) to mount them to the modular stage platform 3 at particular stage platform coordinates. The accessory mounts 7 cooperate with the fittings 17 to secure the accessories 14, 16, 18, 70, 110, 120 to the platform 3. This aids in fast and accurate alignment with objects in virtual reality.

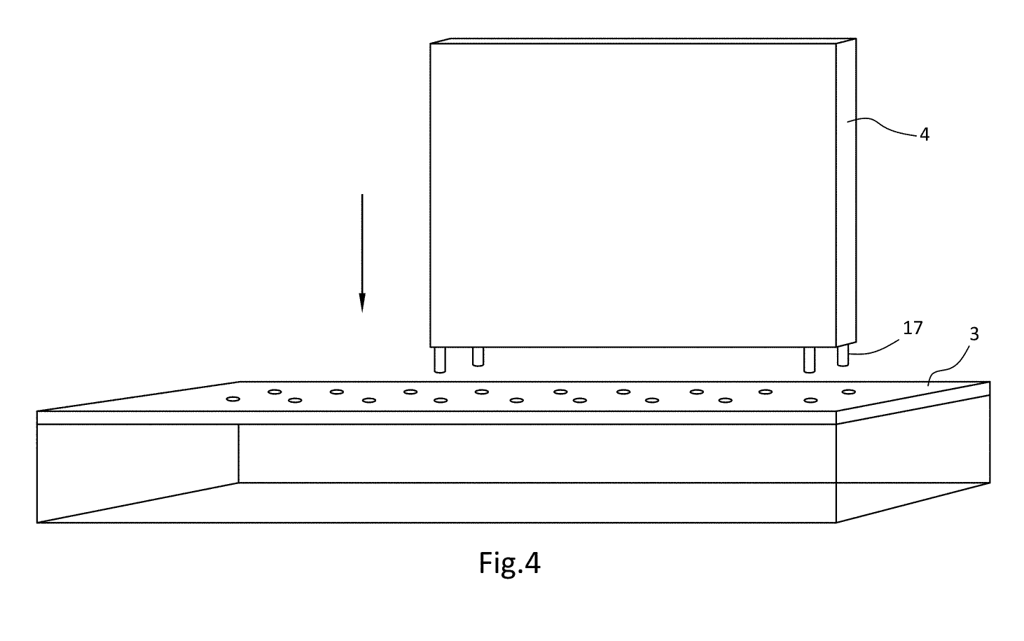

FIG. 4 illustrates this ease of assembly and disassembly by showing a wall section 5 equipped with fittings 17 in the form of pegs positioned over peg holes 7 in a portion of the modular stage platform 3. Assembling the wall section 5 may be as simple as identifying the correct holes on the grid 8 using the alphanumeric markings 9 labeling the grid 8, and inserting the pegs into the holes 7. Disassembling the wall section 5 may be as simple as lifting it from the stage 3. Quick-release clamps or connectors (e.g., clamps or connectors that do not require tools to operate) may optionally be employed, because they would only modestly increase the amount of time needed to assemble and disassemble the accessories 14, 16, 18, 70, 110, 120.

Parts may be added to or subtracted from the kit 11 to create new configurations. In one embodiment, the modular stage 1 includes perimeter walls 5 that are also covered in a labeled grid pattern 8, facilitating fastening of objects to the walls 5 in precise, discrete, exact, and vertically-aligned locations. A primary modular stage accessory 5, such as an interior wall, may include its own labeled grid and pattern of accessory mounts (not shown) so that one or more secondary modular stage accessories 14, 16, 18, 70, 110, 120 can be accurately mounted to the primary stage accessory 5.

The grid-based approach described above is preferable to several alternative approaches to aligning a virtual world with a physical construction. One common alternative approach is to create a permanent “one-up” VR attraction that has not been designed in a modular fashion. It is not practical to update such attractions, limiting their ability to bring in and appeal to repeat customers. Another approach would require that video sensors and/or other sensors be used to determine the location and orientation of each fixed, stationary modular stage accessory 14, 16, 18. This approach in practice would provide a less accurate and/or reliable means of aligning the virtual and physical worlds than this invention's approach, in which the objects of the VR representation and the physical world are positioned at predetermined coordinates or grid points that select prepositioned accessory mounts 7. Another alternative would involve arranging accessories 14, 16, 18, 70, 110, 120 on to the stage platform 3 at specified coordinates without the benefit of a grid 8 or a patterned arrangement of peg holes or the like. A disadvantage of this approach is that it takes longer to assemble the stage, and with greater chance of error. Another disadvantage of this approach is that stage assemblers cannot assemble a stage as precisely and quickly, this way, as they would with the grid-based approach. The result is that the physical and virtual worlds may not align as precisely as they would with the grid-based approach.

As noted above, in one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

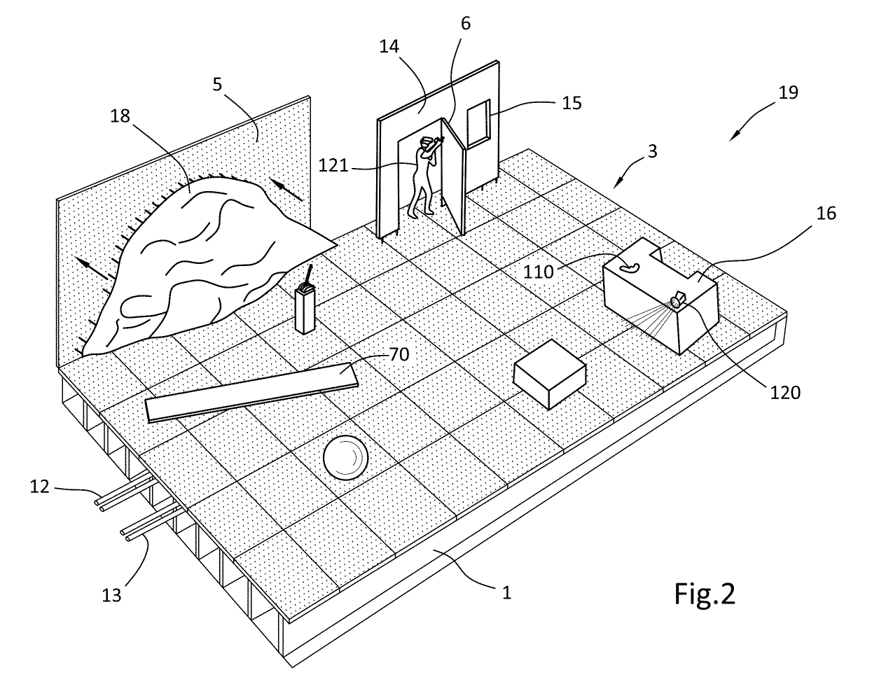

FIG. 2 illustrates the modular stage 1 of FIG. 1 with a second stage plan or arrangement 19 of stage accessories 14, 16, 18, 70, 110, 120 to augment the illusion of a second VR representation. FIGS. 1 and 2 illustrate the speed and convenience with which accessories 14, 16, 18, 70, 110, 120 can be accurately re-arranged on the stage 1 to correspond to different VR representations, with an ease that resembles rearranging Lego® blocks or placing one's ships at the start of a new Battleship® game. Advantageously, this makes it practical for proprietors to engage local customers with new experiences, keeping them coming back again and again.

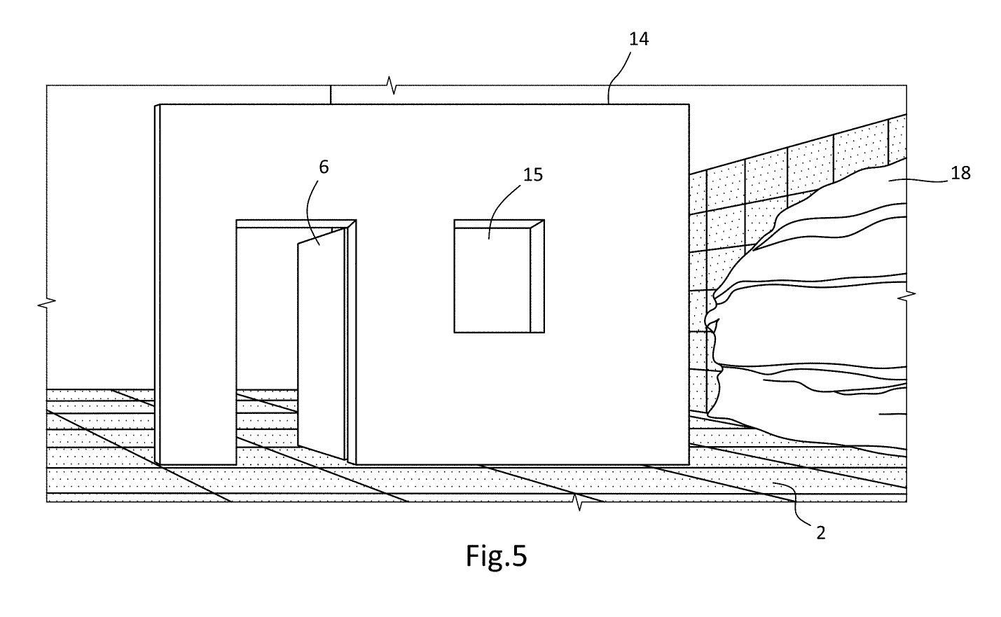

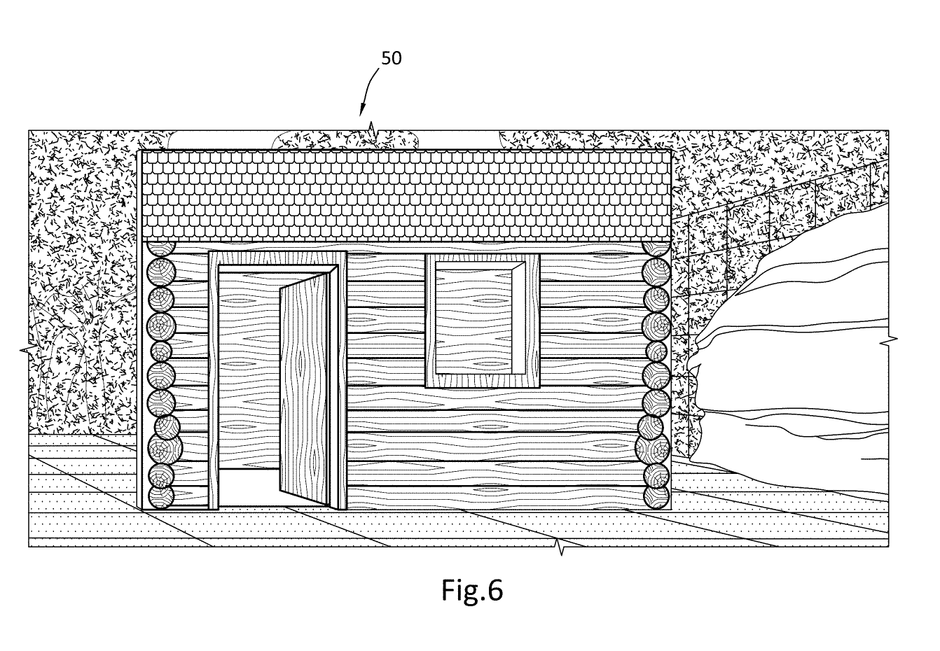

FIG. 5 illustrates a building façade 14 mounted on a modular stage. The building façade 14 comprises a door 6 and window 15 and has simple, flat dimensions. A 3D polystyrene rendering of a rock 18 has the contour of a large rock or boulder and is coated with material like sand and simulated moss to give it a rock-like tactile sensation. FIG. 6 illustrates a VR representation 50 of the building façade 14, embellished with an appearance of log siding and a tiled roof in a wooded surrounding.

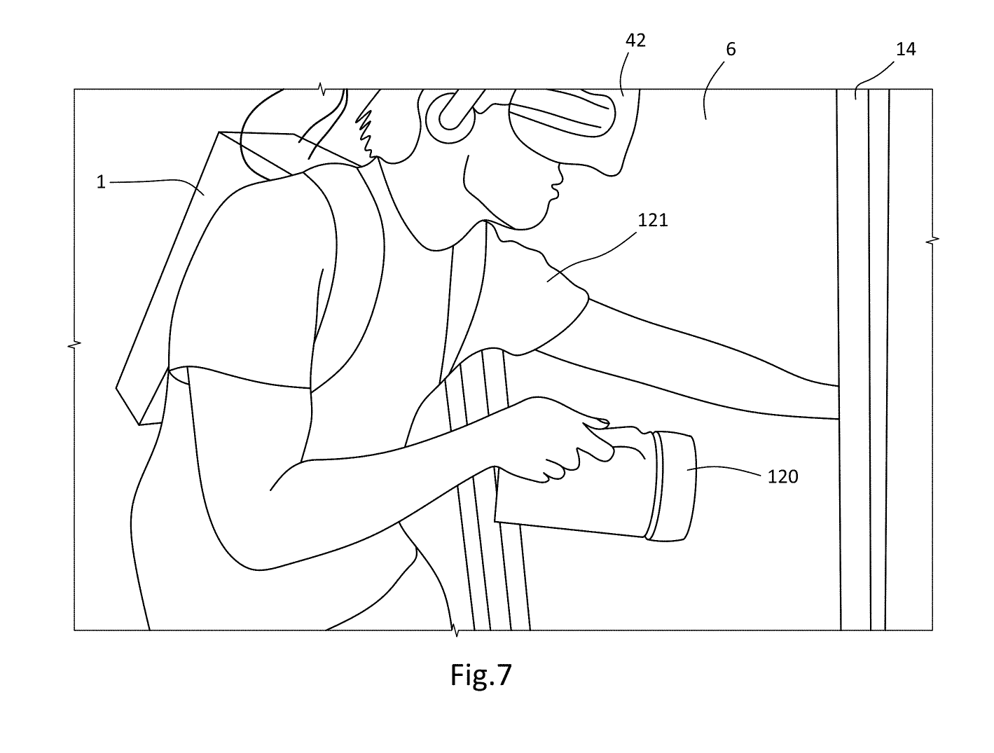

FIG. 7 illustrates a VR participant 121 carrying a backpack 41 and wearing a VR headgear 42. The backpack 41 carries a computer (not shown) running a VR engine. The VR participant 121 is holding a flashlight prop 120 while pushing open the door 6 of the building façade 14. The flashlight prop 120 comprises a conventional flashlight case. To create the flashlight prop 120, any regular-sized battery, and optionally also the light bulb and lens, in the conventional flashlight case are removed. These items are replaced with a smaller power source, orientation sensors and/or a self-tracking beacon so that a motion tracking system (not shown) can determine identification, location, orientation, rotation, movement, and actuation information of the flashlight prop 120.

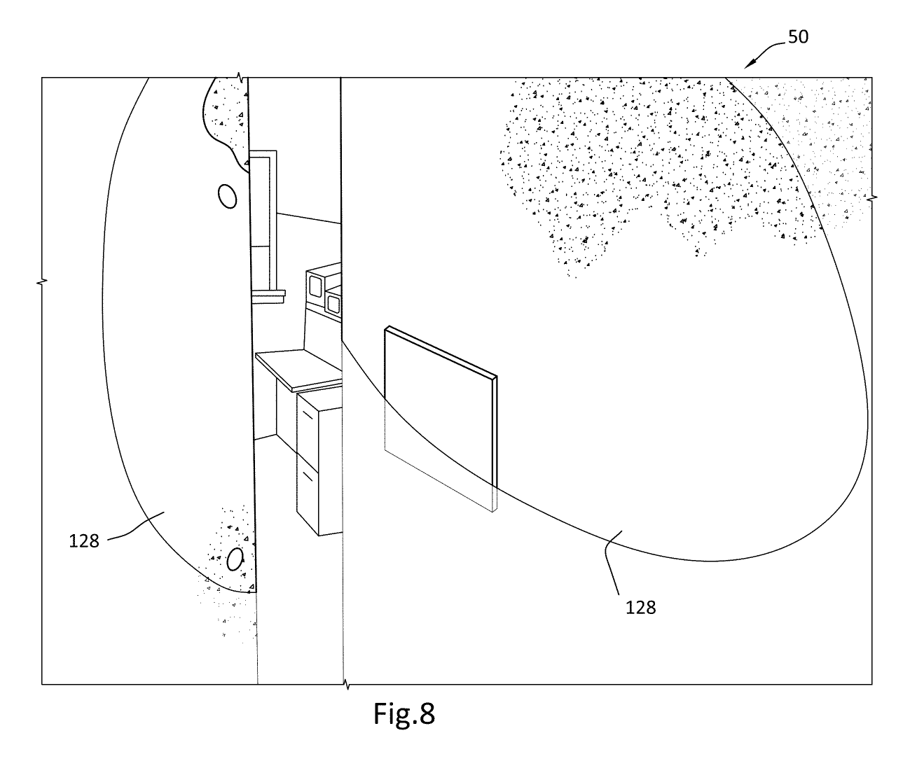

As shown in FIG. 8, a VR engine running on the computer in the backpack 41 receives the identification, location, orientation, rotation, movement, and actuation information of the flashlight prop 120 and renders a VR representation 50 of a flashlight-illuminated portion of the façade 14 and door 6, and a portion of an office beyond the façade 14. In this VR representation 50, which contrasts with the woodsy VR representation 50 of FIG. 6, the doorway is embellished to look aged, with rust spots and paint chips. Elliptical areas 128 are rendered illuminated and the areas around the elliptical areas 128 are rendered dark, corresponding to the direction in which the flashlight prop 120 is pointing. This reinforces the illusion that the sensory information received from the VR headgear 42 is real.

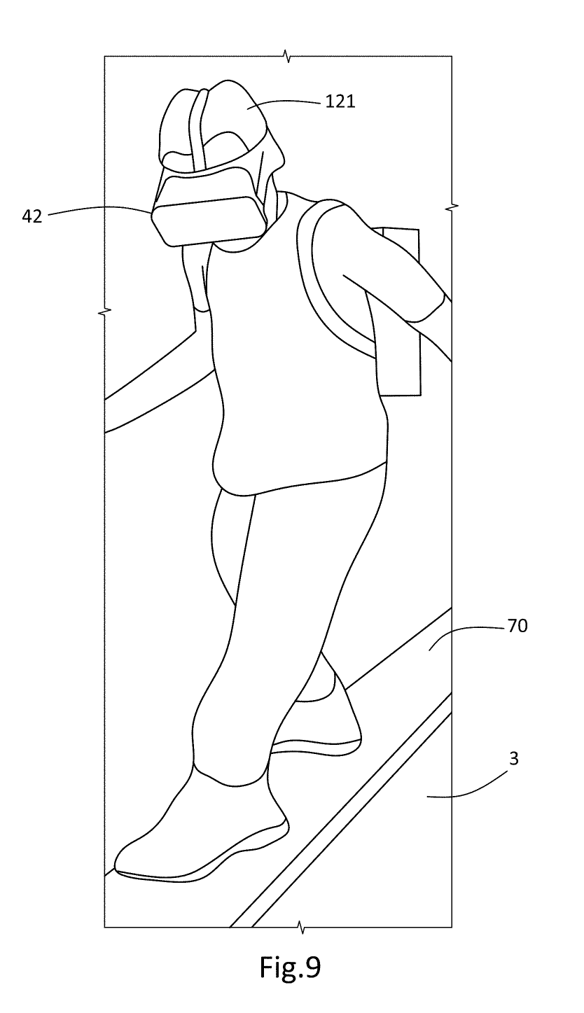

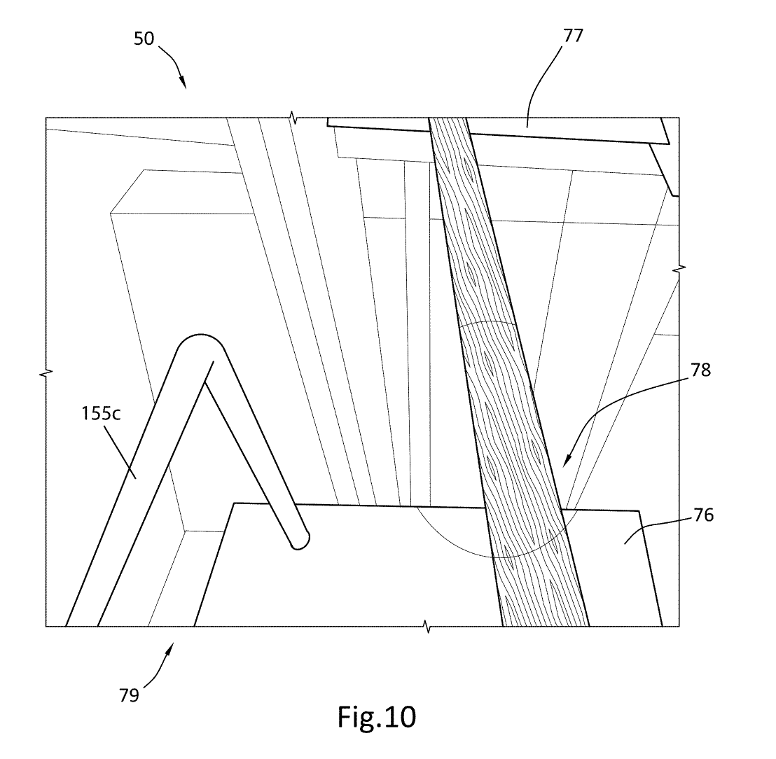

FIG. 9 illustrates the VR participant 121 walking over the wooden plank prop 70 that is shown in FIG. 1 positioned on a modular stage platform 3. The wooden plank prop 70 has a natural warp that causes it to wobble when crossed. The wooden plank prop 70, like the flashlight prop 120, is a moveable smart prop that includes orientation sensors and/or a self-tracking beacon so that a motion tracking system (not shown) can determine identification, location, orientation, rotation, and movement information of the wooden plank prop 70. The VR participant 121 walks very cautiously over the plank 70, even though the plank 70 is safely resting on the platform 3, and the VR participant 121 has a mere 1½ inches to fall should he lose his footing. The VR participant's fear is fueled by the VR representation 50 depicted through the participant's headgear 42. As shown in FIG. 10, the VR participant 121 sees a virtual representation 79 of the plank 70 precariously spanning a deep gap 78 separating two buildings 76 and 77. And when the physical plank 70 wobbles, the motion tracking system employs the identification, location, orientation, rotation, and movement information wirelessly provided from the plank 70 to detect the wobble. Using this information, the VR engine simulates the wobble and the disorienting effect of the wobble on in the VR representation 79 of the plank 70. Sound effects, such as squeaks, wood cracking and splintering further add to the illusion of danger.

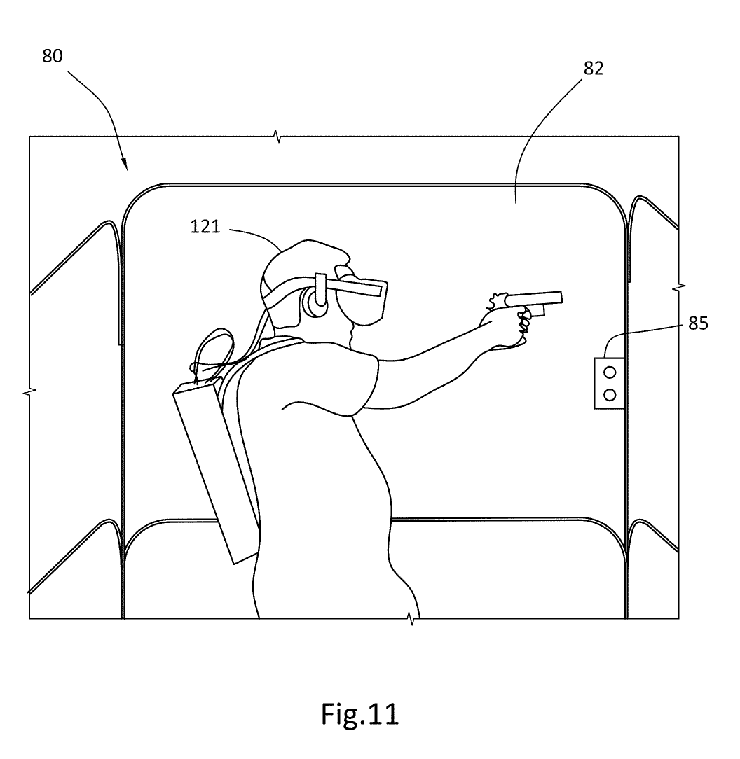

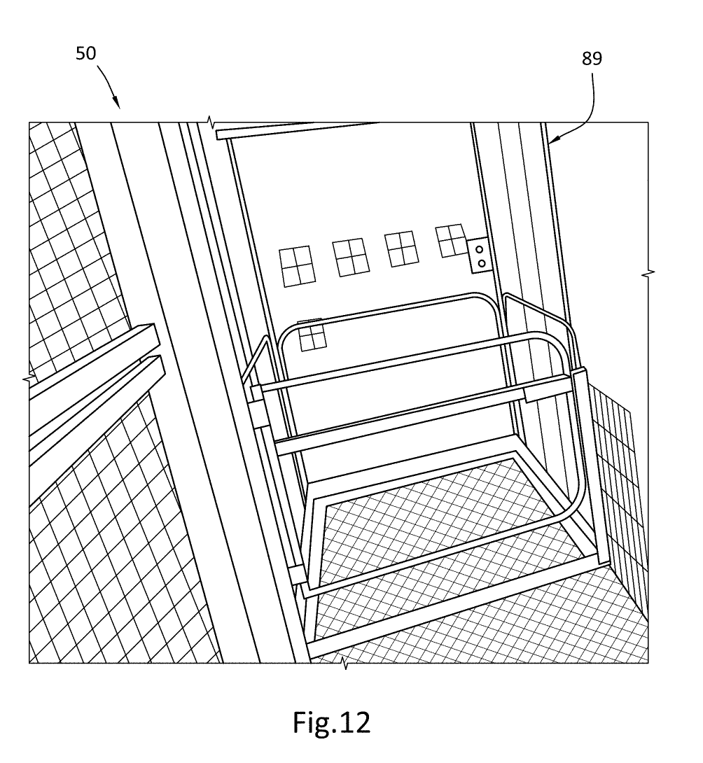

FIG. 11 illustrates the VR participant 121 in one embodiment of an elevator simulator 80 comprising an enclosure 82 made of bars, thatched plates, and/or gates. The simulator 80 may additionally comprise a controller 85 having actuators such as a switch or buttons mounted to the enclosure 82. The elevator simulator 80 is substantially stationary, moving over a span of only a few centimeters or inches to create an illusion of ascending or descending. FIG. 12 illustrates a VR representation 50 of a corresponding VR elevator 89. The VR elevator 89 is shown ascending or descending one or more floors while the corresponding elevator simulator 80 vibrates a platform (not shown) that is coupled to the enclosure 82. The elevator simulator 80 is further described in FIG. 18.

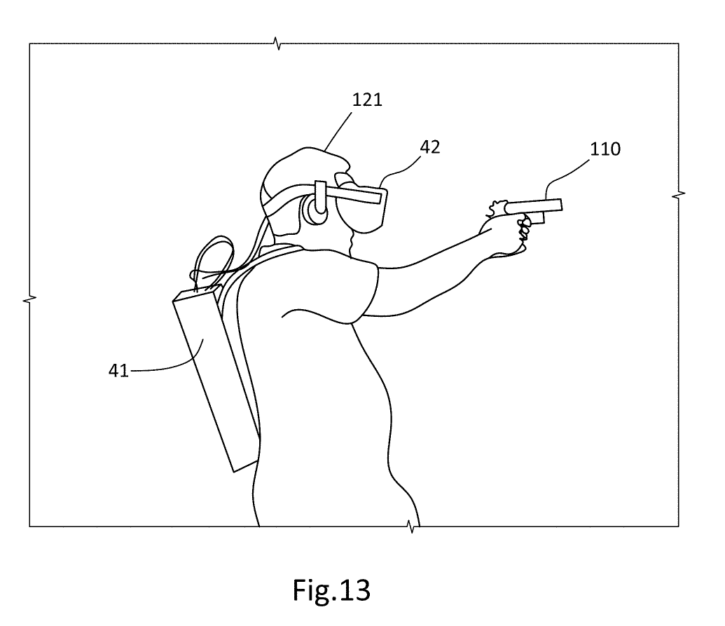

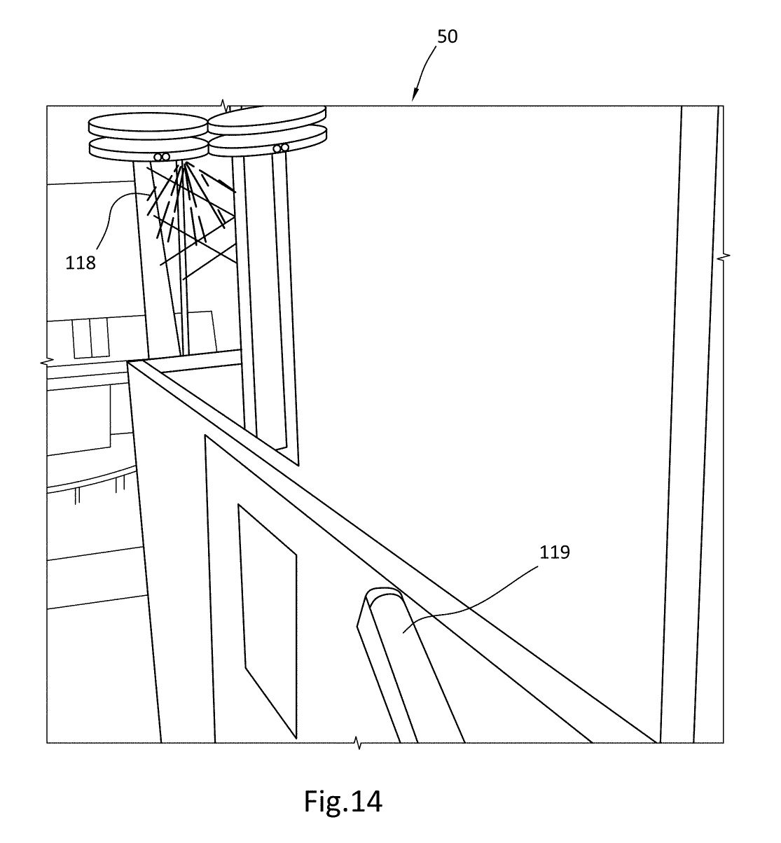

FIG. 13 illustrates the VR participant 121 holding and pointing a firearm prop 110. FIG. 14 illustrates a corresponding VR representation 50 provided to the VR participant 121 as he holds, points, and shoots the firearm prop 110. The VR representation 50 includes a depiction of a VR firearm 119 that is pointed in a direction that corresponds to the direction in which the firearm prop 110 is pointed. The VR representation 50 also depicts kill simulations 118 in response to the VR participant 121 “firing” the firearm 110.

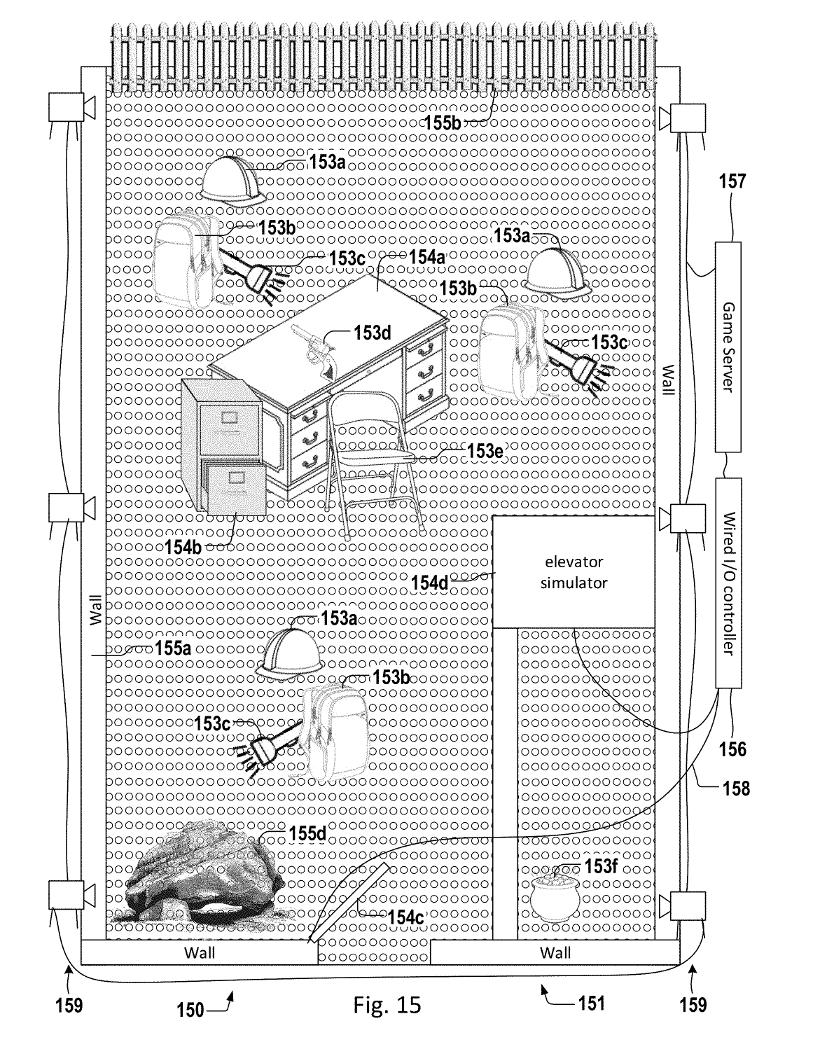

FIG. 15 illustrates a VR system 150 that presents a VR world to players. The VR system comprises a physical space 151, a grid 152, a game server (not shown), and first, second, and third sets of components 153-155. Accoutrements for three players are shown, but the players are ghosted out to declutter the drawing.

The physical space 151 enables players to advance through and interact with other players. The grid 152 is set up in the physical space 151. The grid 152 provides discrete locations for setting up both fixedly mounted and free-standing physical objects that provide a tactile substrate for virtual objects presented in the VR world.

The first set of components 153a -f (collectively referred to as 153 in this description) comprise unfixed mobile components that are tracked using motion tracking LEDs or retroreflective markers. The first set of components 153 comprises, for example, headgear 153a, 3D goggles 42 (FIG. 9), or other wearable items 153b (such as backpacks 41 or other accoutrements bearing LEDs or retroreflective markers) worn by the players. The first set 153 also includes one or more of the free-standing physical props that are configured to be moved, carried, or manipulated by the players, wherein the first set of components utilizes LEDs or retroreflective markers to wirelessly communicate with a game server. Prop examples include a flashlight prop 153c or 120 (FIG. 1), a firearm prop 153d or 110, a chair 153e, a gold-filled pot prop 153f, a plank 70, and a torch prop (not shown) which is not actually lit, but whose appearance is rendered by the VR system as having flame and giving light. Another example, not shown, would be a suitcase full of prop money. The prop money may be dimensioned like cash and have a cash-like texture and may or may not be embellished to have a similar appearance to genuine bills.

The second set of components 154a-d (collectively referred to as 154) is fixedly mounted or at least partially mounted on the grid 152. Two fixedly mounted examples are a desk 154a and filing cabinet 154b. Sensors detect when certain drawers are opened or closed. One partially fixed example is a fixed door frame (e.g., part of façade 14 of FIG. 7) to which an axially fixed swinging door 154c or 6 (FIG. 5) is attached. In one implementation, an angle sensor or motion tracking LEDs or retroreflective markers is installed on a distal part of the door 154c or 6 to track how far the door 154c or 6 is open. Another example (not shown) is a swinging gate accompanied by two fixed posts. Yet another example is an elevator simulator 154d or 80 (FIGS. 11, 12) having a fixed base and a moving or vibrating platform. The second set of components 154 are wired to a wired I/O controller 156 to control the physically mounted components. An example is a heater configured to turn on or off remotely. Yet another example is a façade 14 of a building having a useable door or window 15. The lock can be remotely controlled and a sensor can sense whether and how much a window 15 is opened.

The third set of components 155a-d (collectively referred to as 155) comprise items that are fixedly mounted on the grid 152. But unlike the second set 154, the third set 155 is not tracked or controlled wirelessly or via wire 158. Examples include a wall 155a, a fence 155b, a rail 155c (FIG. 10), and a rock-like molding 155d or 18 (FIG. 1).

The game server 157 relies on a combination of the first, second, and third sets of components 153-155 to provide an immersive, shared experience of the VR world to the players. The game server 157 serves updates to the first and second sets of components 153 and 154 via WiFi and wire 158, respectively. The game server 157 does not gather data from the third set of components 155.

In one embodiment, the VR system 150 includes a motion tracking system 159 comprising an array of cameras positioned along a perimeter of the physical space 151 and/or over the physical space 151. In one implementation, the motion tracking system 159 transmits data using WiFi to the game server 157. In another implementation, the motion tracking system 159 transmits data over wire 158 to the game server 157.

The game server 157 serves constructs of a VR world (the VR engines perform the final rendering) having thematically-embellished virtual objects that are virtually (as a player perceives it through his or her headgear) located in positions and orientations that match the positions and orientations of the free-standing physical props and thematic objects. The game server 157 interprets the data from the motion tracking system 159 and transmits the interpreted data to headgear 153a or 42 worn by the players. When the players reach out far enough to touch the thematically-embellished virtual objects, they feel a corresponding physical object, providing the players with a tactile experience that is consistent with and augments the VR world's audiovisual experience.

The VR system further comprises an inventory tracking system having a scanner, both embodied in a handheld computer that includes a WiFi circuit. The inventory tracking system scans the physical space 151 and registers free-standing physical props found within the physical space 151, and identifies whether each free-standing physical prop is in the physical space 151, and if so, whether the free-standing physical prop is properly positioned and oriented in the physical space 151. An inventory tracking system is further described in U.S. Provisional Patent Application No. 62/618,030, filed Jan. 16, 2018, and the non-provisional of that application, which is being filed on the same day, Jan. 16, 2019, as the instant application, and both of which are herein incorporated by reference.

The VR system further comprises a chip or tag located in each prop that provides identification (ID) information (e.g., RFID) identifying the free-standing physical prop to the inventory tracking system. The inventory tracking system collects 3D scan data from the scanner and collects the ID information from the chips and/or tags.

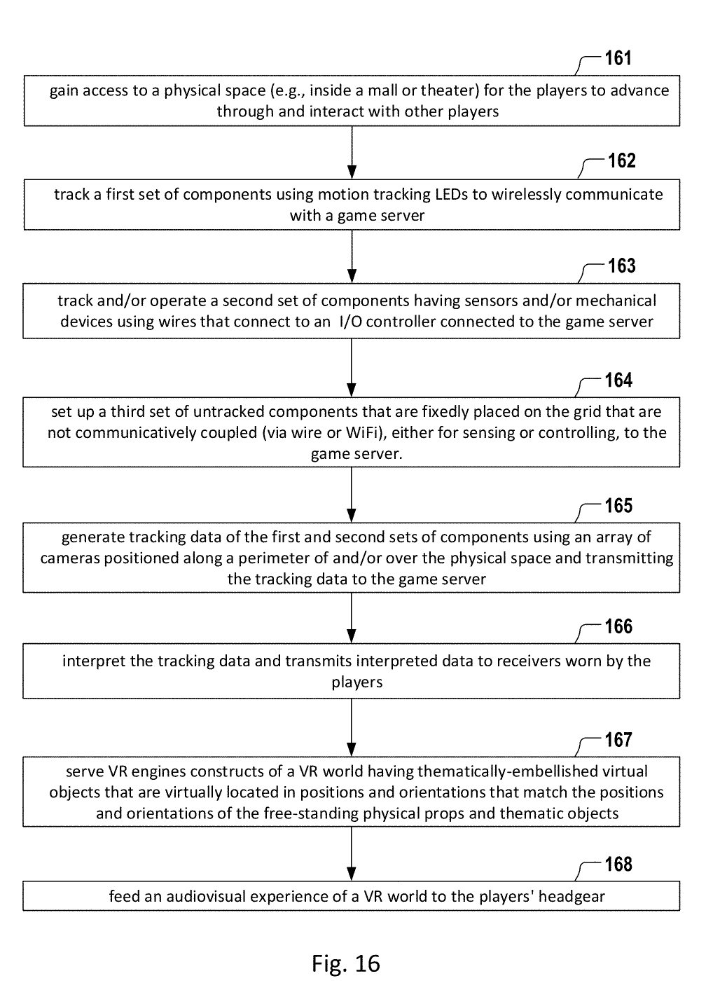

FIG. 16 is a flow chart of one embodiment of a method of presenting to players a VR world comprising integrated audio, visual, and tactile components. It will be apparent that the order in which the instructions are carried out can be changed in many different ways. The first instruction (block 161) is to gain access to a physical space 151 (e.g., inside a mall or theater) for the players to advance through and interact with other players. The physical space should provide discrete locations for setting up both fixedly mounted and free-standing physical objects. These objects provide a tactile substrate for virtual objects presented in the VR world.

In this embodiment, the game server 157 uses a combination of the first, second, and third sets of components 153-155 to provide players an immersive, shared experience of the VR world. (In other embodiments, components are grouped in other ways). The instruction set forth in block 162 provides that a first set of components 153 should be tracked using motion tracking LEDs or retroreflective markers to wirelessly communicate with the game server 157. The instruction set forth in block 163 provides that a second set of components 154 are wired to a wired I/O controller 156. The instruction set forth in block 164 provides that a third set of components 155 are fixedly placed on the grid 152 but unlike the other two sets 153 and 154, are not tracked wirelessly or via wire 158.

As noted in connection with FIG. 15, the first set of components 153 comprises headgear or wearable items worn by the players and one or more of the free-standing physical objects (such as props that are configured to be moved, carried, or manipulated by the players). The second set of components 154 are fixedly mounted on a physical space 151 provided for operation of the VR system. By contrast, the third set of components 155 are not communicatively coupled (via wire or WiFi), either for sensing or controlling, to the game server 157.

The instruction set forth in block 165 calls for tracking movements and generating tracking data of the first and second sets of components 153 and 154 using an array of cameras positioned along a perimeter of and/or over the physical space 151 and transmitting the tracking data to the game server 157. For most of the first set of components 153, tracking data is sent using WiFi to the game server 157. Tracking data from the second set of components 154 is sent by wire 158 to the wired I/O controller 156.

The instruction set forth in block 166 calls for the game server 157 to interpret the tracking data and transmits interpreted data to headgear (e.g., VR headsets) worn by the players and furthermore serves updates to the second set of components 154 via WiFi.

The instruction set forth in block 167 calls for the game server 157 serves the VR engines (computer processing components of the VR system 150 that are carried by players) constructs of a VR world having thematically-embellished virtual objects that are virtually located in positions and orientations that match the positions and orientations of the free-standing physical props and thematic objects.

The instruction set forth in block 168 calls for the VR engines to feed an audiovisual experience of a VR world to the players' headgear. The players carry VR engines on their persons (using, for example, backpacks) in order that generate and feed player-specific audiovisual experiences and perspectives of a VR world to the players' headgear.

During a VR game, one or more of the players are likely to reach out far enough to virtually touch (as perceived in the VR world by the player) one of the thematically-embellished virtual objects. When players do so, they feel a corresponding physical object. This provides the players with a tactile experience that is consistent with and augments the VR world's audiovisual experience.

I/we claim:

1. A virtual reality (VR) system that presents a VR world to players, the VR system comprising:
a physical space for the players to advance through and interact with other players;
a grid in the physical space, the grid providing discrete locations for setting up both fixedly mounted and free-standing physical objects that provide a tactile substrate for virtual objects presented in the VR world;
a game server;
a first set of components that:
are unfixed to the grid;
mobile;
include head gear worn by the players;
further include one or more free-standing physical props that are configured to be moved, carried, or manipulated by the players;
are tracked using motion tracking LEDs; and
wirelessly communicate with the game server;
a second set of components that are wired to a wired I/O controller to control objects that are fixedly mounted on a physical space provided for operation of the VR system; and
a third set of components that are imaged but not tracked through signals transmitted wirelessly or via wire, the third set of components being items that require accurate and at least partially fixed placement on the grid;
wherein the game server relies on a combination of the first, second, and third sets of components to provide an immersive, shared experience of the VR world to the players.

2. The VR system of claim 1, further comprising a motion tracking system comprising an array of cameras positioned along a perimeter of and/or over the physical space;
wherein the motion tracking system transmits data using WiFi to the game server; and
wherein the game server interprets the data from the motion tracking system and transmits interpreted data to receivers worn by the players.

3. The VR system of claim 1, wherein the game server serves updates to the first set of components via WiFi.

4. The VR system of claim 1, further comprising VR engines carried by the players that feed an audiovisual experience of a VR world to the players' headgear;
wherein the game server serves the VR engines constructs of the VR world having thematically-embellished virtual objects that are perceived to be located, that is, virtually located, in positions and orientations that match the positions and orientations of the free-standing physical props and thematic objects.

5. The VR system of claim 4, wherein when the players reach out far enough to virtually touch, that is, to perceive contact with, the thematically-embellished virtual objects, they feel a corresponding physical object, providing the players with a tactile experience that is consistent with and augments the VR world's audiovisual experience.

7. The VR system of claim 1, comprising at least one of the following examples of free-standing physical props:
a firearm prop; and
a plank.

6. The VR system of claim 1, further comprising at least one of the following examples of fixedly-mounted objects:
a wall;
a fence;
a rail;
a gate;
a façade of a building having a useable door or window;
a rock-like molding; and
an elevator simulator.

8. The VR system of claim 1, wherein the items that require at least partially fixed placement on the grid and comprise at least one of the following:
a fixed door frame to which an axially fixed swinging door is attached;
two fixed posts to which one of the posts, an axially fixed swinging gate is attached;
a fixed building façade that includes a partially fixed swinging door; and
an elevator simulator having a fixed base and a platform that moves up and down with respect to the fixed base.

9. The VR system of claim 1, further comprising an inventory tracking system having a scanner, wherein the inventory tracking system:
scans the physical space and registers the free-standing physical props found within the physical space;
identifies whether each free-standing physical prop is in the physical space, and if so, whether the free-standing physical prop is correctly positioned and oriented in the physical space.

10. The VR system of claim 9, further comprising a chip or tag located in each free-standing physical prop that provides identification (ID) information (e.g., RFID) identifying the free-standing physical prop to the inventory tracking system, wherein the inventory tracking system:
collects 3D scan data from the scanner; and
collects the ID information from the chips and/or tags.

11. The VR system of claim 9, wherein the inventory tracking system is embodied in a handheld computer that includes a WiFi circuit.

12. A method of presenting to players a VR world comprising integrated audio, visual, and tactile components, the method comprising:
gaining access to a physical space for the players to advance through and interact with other players;
providing discrete locations for setting up both fixedly mounted and free-standing physical objects that provide a tactile substrate for virtual objects presented in the VR world;
tracking a first set of components using motion tracking LEDs to wirelessly communicate with a game server, wherein the first set of components comprises headgear or wearable items worn by the players and one or more of the free-standing physical objects;
operating a second set of components that are wired to a wired I/O controller, the second set of components being fixedly mounted on a physical space provided for operation of the VR system;
setting up a third set of components that are imaged but not tracked through signals transmitted wirelessly or via wire from the components to the game server, the third set of components being fixedly mounted in the physical space; and
using the game server and a combination of the first, second, and third sets of components to provide players an immersive, shared experience of the VR world;
wherein the free-standing physical objects include free-standing physical props that are configured to be moved, carried, or manipulated by the players.

13. The method of claim 12, further comprising the game server constructing a perceptible VR world with VR objects that correspond in shape and spatial position to the third set of components.

14. The method of claim 13, further comprising the game server detecting and/or controlling operation of the second set of components.

15. The method of claim 14, further comprising the game server detecting movements and/or orientations of the headgear or wearable items of the first set of components to determine what VR vantage to provide to each player.

16. A method of presenting to players a VR world comprising integrated audio, visual, and tactile components, the method comprising:
gaining access to a physical space for the players to advance through and interact with other players;
providing discrete locations for setting up both fixedly mounted and free-standing physical objects that provide a tactile substrate for virtual objects presented in the VR world, wherein the free-standing physical objects include free-standing physical props that are configured to be moved, carried, or manipulated by the players;
tracking a first set of components using motion tracking LEDs to wirelessly communicate with a game server, wherein the first set of components comprises headgear or wearable items worn by the players and one or more of the free-standing physical objects;
operating a second set of components that are wired to a wired I/O controller, the second set of components being fixedly mounted on a physical space provided for operation of the VR system;
transmitting the tracking data for the first set of components using WiFi to the game server;
transmitting the tracking data for the second set of components over wires to the game server; and
interpreting the tracking data and transmitting interpreted data to receivers worn by the players to generate constructs of the virtual world so that thematically-embellished virtual objects that are virtually located in positions and orientations that match the positions and orientations of the free-standing physical props and thematic objects.

17. The method of claim 16, further comprising:
one of the players reaching out far enough to touch one of the thematically-embellished virtual objects; and
the player feeling a corresponding physical object, providing the players with a tactile experience that is consistent with and augments the VR world's audiovisual experience.

18. The method of claim 16, wherein components that require completely fixed placement in the physical space comprise at least one of the following:
a wall or a fixed door frame to which an axially fixed swinging door is attached;
two fixed posts to which one of the posts, an axially fixed swinging gate is attached;
a fixed building façade that includes a partially fixed swinging door; and
an elevator simulator having a fixed base and a platform that moves up and down with respect to the fixed base.

19. The method of claim 12, further comprising:
acquiring an inventory tracking system having a scanner;
scanning the physical space with the inventory tracking system:
registering ones of the free-standing physical props found within the physical space with the inventory tracking system; and
identifying whether each required free-standing physical prop is in the physical space, and if so, whether the required free-standing physical prop is properly positioned and oriented in the physical space, where both identifications are performed by the inventory tracking system.

20. The method of claim 19, wherein a chip or tag is located in each free-standing physical prop that provides identification (ID) information (e.g., RFID) that identifies the free-standing physical prop to the inventory tracking system, wherein the inventory tracking system, the method further comprising:
collecting 3D scan data from the scanner; and
collecting the ID information from the chips and/or tags.
